(19) United States
(12) Patent Application Publication
(10) Pub. No.: US 2008/0273081 A1
(43) Pub. Date: Nov. 6, 2008

(54) Business system for two and three dimensional snapshots

(76) Inventor: Lenny Lipton, Los Angeles, CA (US)

Correspondence Address: SMYRSKI LAW GROUP, A PROFESSIONAL CORPORATION, 3310 AIRPORT AVENUE, SW, SANTA MONICA, CA, 90405, US

(21) Appl. No.: 12/079,484

(22) Filed: Mar. 26, 2008

Related U.S. Application Data
(63) Continuation-in-part of application No. 11/717,355, filed on Mar. 13, 2007.

(51) Int. Cl. H04N 13/00; H04N 13/04

(52) U.S. Cl. 348/42; 348/60; 348/E13.001; 348/E13.007

(57) ABSTRACT

A method for enabling viewing of stereoscopic images is provided. The method includes providing a two dimensional image representation to a service bureau configured to convert the two dimensional image representation into a stereoscopic image and transmitting the enhanced image from the service bureau to an entity for purposes of displaying the images in a user desired configuration, such as in a digital photo frame. Alternately, the present design includes receiving a two dimensional electronic image representation in electronic form together with conversion criteria, converting the two dimensional electronic image representation into a stereoscopic image based on the conversion criteria, and providing the stereoscopic image to a user for display.

This application is a continuation-in-part of co-pending U.S. patent application Ser. No. 11/717,355, entitled “Business System for Three-Dimensional Snapshots,” inventors Lenny Lipton, et al., the entirety of which is incorporated herein by reference.

### BACKGROUND OF THE INVENTION

1. Field of the Invention

The present invention relates generally to the art of three-dimensional snapshot or still digital photographic picture taking, along with an infrastructure that can be used for displaying images in various formats. More specifically, planar or 2D information that has been photographed by a conventional still camera can be reformatted to various viable viewing modalities such as hardcopy, or for viewing on an electronic display, either with eyewear selection devices or autostereoscopically, as well as by means of the product known as a digital photo frame.

2. Description of the Related Art

Digital photographic technology now dominates today's photographic marketplace with consumers enjoying its ease, and low cost, due in part to the absence of a need for film or film processing, and the ability to readily transfer digital images between devices, such as cell phones, PDAs, computers, TV screens, digital photo frames, and to share images electronically by means of the Internet, and so forth.

However, stereoscopic digital photography by amateur photographers does not now exist as a viable commercial product. No currently available commercial system enables a user to either take or view stereoscopic digital photographs or images. Further, current technology for enabling a user to view stereoscopic digital still images does not include the ability for the user to select amongst various stereoscopic viewing modalities such as hardcopy, or on an electronic display screen, using either active or passive eyewear or even autostereoscopically (without eyewear).

Current consumers would undoubtedly enjoy being able to view three dimensional digital images on a variety of media and/or devices. It is therefore advantageous to offer simple, flexible, practical, and potentially low cost digital stereoscopic image viewing arrangements and infrastructure, including an ability to view such digital stereoscopic images using various modalities. Moreover, photography is the world's most popular hobby, making the lack of a digital stereoscopic commercial infrastructure all the more apparent and a compelling business opportunity.

### SUMMARY OF THE INVENTION

According to one aspect of the present design, there is provided a method for enabling viewing of stereoscopic images. The method includes providing a two dimensional image representation to a service bureau configured to convert the two dimensional image representation into a stereoscopic image and transmitting the enhanced image from the service bureau to an entity for purposes of displaying the images in a user desired configuration, such as in a digital photo frame.

According to a second aspect of the present design, there is provided a method for enabling viewing of stereoscopic images that includes receiving a two dimensional electronic image representation in electronic form together with conversion criteria, converting the two dimensional electronic image representation into a stereoscopic image based on the conversion criteria, and providing the stereoscopic image to a user for display.

These and other advantages of the present invention will become apparent to those skilled in the art from the following detailed description of the invention and the accompanying drawings.

### BRIEF DESCRIPTION OF THE DRAWING

The present invention is illustrated by way of example, and not by way of limitation, in the figure of the accompanying drawing in which:

FIG. 1 is a flow chart showing the digital three-dimensional image system conversion and transmission infrastructure; and

FIG. 2 illustrates an embodiment of one implementation of the current design, specifically including providing an image to a display facilitator such as a software program, to a service bureau configured to convert two dimensional images into stereoscopic images, and ultimately to a user employing, for example, a digital photo frame.

### DETAILED DESCRIPTION OF THE INVENTION

The first stereoscopic images were photographed in 1839 and subsequently there have been a vast number of designs and products offered up and including the present day. This disclosure does not seek to place limitations on the origination of the stereo-pairs but rather seeks to embrace all such cameras and techniques for producing such content. In point of fact, stereo cameras, after 170 years, remain in the minority. It is the goal of this disclosure to describe a means for users of the vast majority of cameras, planar cameras, to obtain the benefits of three-dimensional photography but most notably without the requirement of using a stereo camera. Stereo cameras require more skill to use than planar cameras and lock in a specific three-dimensional effect that may not be the most pleasing to a user.

Interestingly, the synthetic processing or conversion of a three-dimensional image from an original planar image may well produce a more pleasing three-dimensional result.

The present design takes 2D images and converts the 2D image into stereoscopic or autostereoscopic format using a display facilitator, such as a software program or individual who directs the images to an entity such as a service bureau. The display facilitator receives the converted image and provides the converted image to the user for display in a manner as desired by a user, including but not limited to display using a digital photo frame.

A “digital photo frame” as used herein generally means a picture frame or picture frame type article configured to display digital photos. A computer or television or other display device may be configured to display the digital photos. When using a digital photo frame, there is no need to create physical hard copies of the photo, but the photos can be displayed, such as by a slideshow or individually or randomly as desired by the user. A single image can be constantly displayed, or multiple images can be presented in the digital photo frame. Internal memory storage can be provided, and the digital photo frame includes processing and display capability for digital images, including but not limited to images in jpeg, GIF, bmp, and other image formats.

One aspect of the present design is a method that enables viewing of stereoscopic images which have been photographed with a planar or 2D camera. The method includes generating a stereo pair of images or a multiplicity of images suitable for autostereoscopic display (such as by means of the SynthaGram, a device available from REAL D of Beverly Hills, Calif.) in digital form. The method uses at least one 2D image recording device or camera configured to produce a conventional planar image. The method includes offering the user the ability to create stereo images derived from planar images by means of a display present design also enables the user to elect display from a display facilitator, which may include a service bureau, as well as a device configured to print the stereoscopic image, or a device configured to display the stereoscopic or autostereoscopic image.

The display facilitator may facilitate display of the stereoscopic or autostereoscopic image using electronic or hardcopy means, such as by converting the 2D image to a stereoscopic or autostereoscopic image. The user can choose a display facilitator to receive the planar image and can view at least one stereoscopic image resulting from generation of stereo or autostereo images from the planar to stereo or autostereo conversion process.

Once the user receives the image from the display facilitator, the user can display the derived or converted stereoscopic image using a PC or similar device via his display screen or using a printer to produce paper or similar hardcopy prints. In addition, traditional planar displays or prints may also be produced and viewed, and the user may receive the three dimensional image in electronic form and the image may be provided to a specialized device, such as a digital photo frame.

Thus the present design is a planar to stereo-pair or autostereoscopic infrastructure that uses a display facilitator, such as a service bureau, wherein conventional 2D photos are converted, by well known means, to 3D pictures that can be viewed by means of various display modalities but especially by autostereoscopic modalities and especially by means of digital photo frame.

What is therefore described herein is a planar to stereo-pair or autostereoscopic infrastructure by means of a service bureau wherein conventional 2D photos are converted, by generally well known means employed at the service bureau, to 3D pictures that can be viewed by means of various display modalities, particularly by autostereoscopic modalities and especially by means of digital photo frame.

The present design includes an infrastructure beginning with a camera or image capture device employed to capture standard 2D or planar images, and a design to process these images so that they can be viewed on a personal computer (PC) screen or other electronic display screen such as a digital photo frame, or alternately, as hardcopy. The intended user can lack sophisticated technical skills, and the system takes such abilities or limitations into account. The infrastructure system is flexible insofar as it allows choices to be made with regard to the degree of creative effort required in facilitating creation of an image. That is to say, the user is able to decide whether to accept his or her photo in two dimensional form or to have the two dimensional image converted for display as a three-dimensional image. This methodology is in accordance with traditional approach to photography and snapshot taking and snapshot viewing that has evolved over more than a century. In addition, the user can communicate to the service bureau regarding desired depth effects and/or other applicable conversion criteria that dictate the desired stereoscopic effects and/or conversion settings. Changes can be made to the finished image provided in accordance with the user's preferences. Alternately, the user can provide the means or device by which the image will most likely be displayed, and the service bureau or the user may convert the device settings or standards to desired or desirable depth effects or other pertinent parameters.

As used herein, the term “service bureau” is intended to be construed broadly, but is generally understood to those skilled in the photographic image arts as an entity that provides services that may be beyond the capabilities of a typical user or to provide such services because they are more conveniently provide by a specialist entity. Such a service bureau can perform a variety of tasks, including but not limited to producing transparencies, prints, or negatives, digital files, scanning in high resolution color or black and white, image editing, and ultimately producing a viewable image in a desired format. Service bureaus are known by many names, including “digital imaging center” or “process shop.” As used herein, the term “service bureau” generally follows this definition but may include other related entities. These days digital files may be transmitted to the service bureau, by means of the Internet for example, and the bureau may provide a variety of functions such as print making, producing hardcopy or softcopy albums, calendars, and the like. Or they may provide a depository for files to be shared with clients, friends, and relatives. Of particular interest in the context of this design is preparation of files, such as digital image files, that can be converted and/or viewed autostereoscopically on a digital photo frame.

Once received or taken, the planar images may be processed or converted to three-dimensional form using processes, procedures, and functions that are generally well known and have in recent years been pursued in the context of conversion of planar movies to stereopsic movies by entities such as Sony Pictures Imageworks, Industrial Light and Magic, Conversion Works, or In-Three. One means for conversion from planar to three dimensional that is representative of the entire field is discussed in “Interactive 2D to 3D Stereoscopic Image Synthesis” by Feldman and Lipton, published in Stereoscopic Displays and Virtual Reality Systems Proceedings of the SPIE-IS&T Electronic Imaging, SPIE Vol. 5664, the entirety of which is incorporated herein by reference.

The process described in the Feldman and Lipton article is the one used, more or less, throughout the industry. The process involves outlining the image portions of interest, applying depth maps to those portions with appropriate depth choices selected by a user or by the person or entity performing the process, either manually or automatically, and properly separating foreground from background. As a consequence, hidden or missing background material must be filled in or plugged by means of cloning image areas or by means of artistic intervention. The process is one of craft involving human intervention coupled with computer aided devices and algorithms. Given the present state of the art, the process tends to be heavily dependent upon an operator's skill and experience.

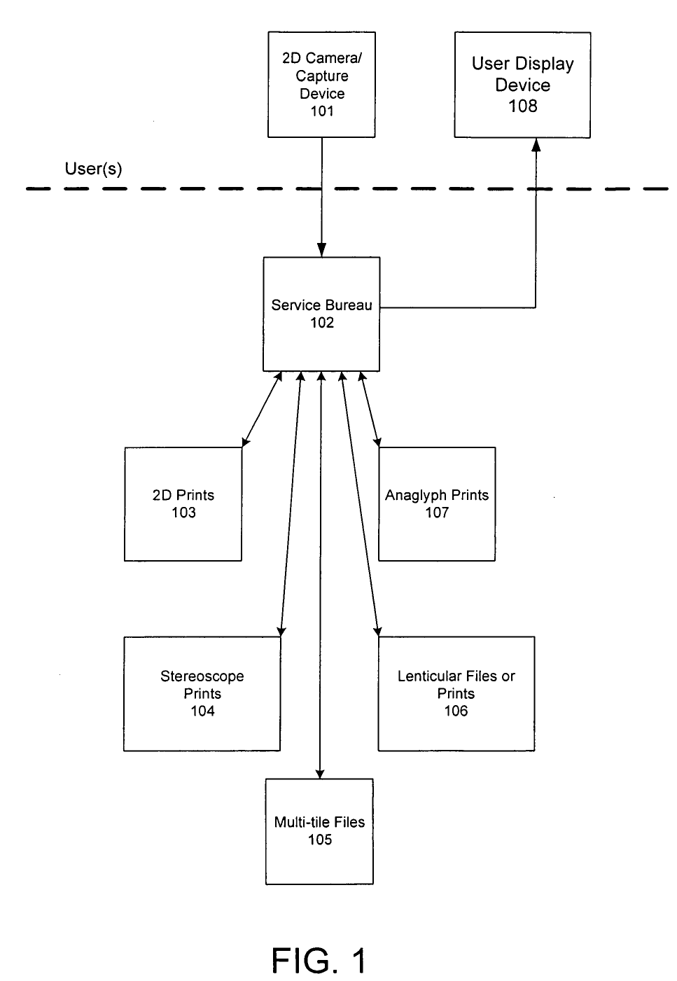

FIG. 1 illustrates the infrastructure of the system that is central to the current design. The image capture device 101 is typically a 2D camera or a device employable to create two dimensional images. Electronic files from image capture device 101 are transmitted to the Service Bureau 102—uploaded by the user by means of the Internet, sent by mail, or brought to the camera shop or similar location offering the facilitation services described herein.

The service bureau 102 can then processes the files to produce conventional 2-D prints 103, and/or may employ other methods enumerated herein. The option for the customer to receive 2D prints, effectively operating as a conventional photograph developer, is beneficial. For all display options other than a two dimensional print option, the service bureau 102 must make a conversion to turn the 2D image into a three-dimensional image representation, in the manner discussed above, such as for example using the teachings of the Feldman and Lipton article.

In the case of the Anaglyph Print 107, software is provided to Service Bureau 102 so that the left and right images may be turned into monochrome or color anaglyph prints and then presented in hardcopy form to be viewed with red-green or red-blue glasses. Such anaglyphs may be provided either as hardcopy or as electronic files which may be provided to and viewed on a TV or PC display screen. Processes and procedures for turning two images into the foregoing, namely monochrome or color anaglyph prints (stereo pairs that can be viewed in a stereoscope) are known to those skilled in the art of stereoscopic print developing and production. By way of example, such processes are discussed in “The World of 3-D” by Ferwerda, 3-D Book Productions, The Netherlands, 1990, “Stereo-Photography” by Linssen, The Fountain Press, London, 1952, and “Stereoscopic Photography” by Judge. Chapman & Hall, London, 1950, all of which are incorporated herein by reference. There is also good deal of information on producing anaglyphs available on the Internet.

A special form of the anaglyph, known under the trade name Infitec, can also be employed as the image selection or processing technique. This process uses sharply defined regions of filtration rather than broad filtration in the visible spectrum to provide image selection.

Another alternative is for the service bureau 102 to produce stereoscopic prints 104 in the form of stereo pairs that can be viewed in a stereoscope. The stereoscope is a well-known device employing two lenses (or sometimes a prism or mirrors), each lens devoted to one perspective view. The print may be placed in a holder and then viewed through the stereoscope lenses. The print can also be turned into photographic slides that can be viewed in a stereoscopic slide viewer (stereoscope) such as the ubiquitous ViewMaster device. Stereo pair hardcopy can also be produced, in which left and right image pairs are placed side by side on a single card which can then be viewed in a Holmes-type stereoscope of well-known design. Production of hardcopies such as stereo pair hard copies is generally known in the art. All items procured or produced by the service bureau can be provided to the original user or other users and ultimately to the user display device 108 for viewing by a user or other persons.

The term “print” or “hardcopy” as used herein can also be broadly interpreted as a digital file in which case the stereo pair image, derived from the planar file by means of conversion, can be viewed on an electronic display. This is also called a “file” herein, but the term “print” or “hardcopy” is intended broadly to be an electronic file that can be viewed on a display by means of page-flipping with shuttering or passive eyewear, interdigitated micropolarizer techniques, interlace stereo, or other generally known technology that is well documented in both literature and in practice. Such known technology enables three dimensional viewing by an individual of a physical print or on a display.

An electronic display monitor can be equipped with Arisawa Manufacturing's XPol polarizing material and such a display device can be used to view a stereoscopic print. When viewing the files stereoscopically, the application loaded on the PC to display these image files can be configured for the particular selection device or monitor. A monitor that has interdigitated polarizer or retarder—as manufactured, for example, by Arisawa, known as Xpol, or sometimes known under the brand name Micropol by VRex, can cause the stereo pairs to be interdigitated or treated so that they are line-alternated or pixel-alternated to then be in intimate juxtaposition with the appropriate pixel elements. An early example of this spatially multiplexing or interdigitated technique using rows or columns of alternating polarization is described by Rehorn in “Stereoscopic Viewing Method and Apparatus” U.S. Pat. No. 2,631,496, the entirety of which is incorporated herein by reference. A liquid crystal device of this type was first described by Lipton in “Polarel panel for stereoscopic displays”, U.S. Pat. No. 5,686,975, which is also incorporated herein by reference in its entirety.

Alternately, the left and right images can be time-multiplexed and viewed on an appropriate monitor 218, or projected using a field-sequential monitor. For example, the DLP engine that has been modified by Texas Instruments to allow for stereo pair viewing using diagonal interlace can be used in a front- or rear-projection application. In such a case the image can be viewed through shuttering eyewear such as eyewear sold under the brand name CrystalEyes® or by use of a polarization modulator such as the ZScreen®, available from REAL D/StereoGraphics Corporation of Beverly Hills, Calif.

Yet another option is for the Service Bureau 102 to produce a lenticular autostereoscopic print 106. Such an image is also known as a parallax panoramagram or more simply just as a panoramagram. Interpolation algorithms, many of which are well known, can be used to create the intermediate views that lie between the provided left and right views. When making small sized autostereoscopic prints for lenticular viewing, experiments have shown that the demands for interpolation accuracy are relaxed compared to making very large prints. The lenticular prints consist of a hardcopy overcoated with a lenticular screen so that the stereoscopic image information can be viewed without eyewear. Alternatively, a raster barrier can be used, and as is well understood such barriers are optically interchangeable with lenticular screens.

Okoshi in “Three Dimensional Imaging Techniques”, NY Academic Press, 1976, discusses panoramagram and lenticular stereoscopic technology. The teachings of this Okoshi text are incorporated herein by reference.

In the middle branch shown in FIG. 1, the converted image, in the form of multi-tile data, can be viewed on a display screen monitor. Here the image can be turned into a SynthaGram image (the trade name of a panoramagram product). The SynthaGram is a stereoscopic image that can be viewed without glasses. Various manufacturers produce such lenticular devices (or raster barrier monitors), any of which can be used for autostereoscopic viewing. A list of SynthaGram patents and pending applications that are relevant to the present discussion, pending and granted, is provided in Table 1.

TABLE 1
Relevant SynthaGram patents and pending applications

| | |
|---|---|
| Autostereoscopic pixel arrangment techniques | 09/876,630 |
| Convertible autostereoscopic flat panel display | 10/769,129 |
| Dual mode autostereoscopic lens sheet | 10/779,142 |
| Autostereoscopic lens sheet with planar areas | 10/779,143 |
| Method and apparatus for optimizing the viewing | 10/827,871 |
| distance of a lenticular stereogram | |
| Hardware based interdigitation | 10/956,987 |
| Hardware based interdigitation-continuation | 11/118,516 |
| Stereoscopic format converter | 10/613,866 |
| Tiled view-maps for autostereoscopic | 11/388,352 |
| interdigitation | |
| Multiple mode display device | 11/341,801 |
| On-the-fly hardware based interdigitation | 11/350,534 |
| Autostereoscopic display with planar pass-through | 11/400,958 |
| Controlling the angular extent of autostereoscopic | 11/448,281 |
| viewing zones | |
| Autostereoscopic display with increased sharpness | 11/473,660 |
| for non-primary viewing zones | |
| Temperature compensation for the differential | 11/588,605 |
| expansion of an autostereoscopic . . . | |
| Monitor with integral interdigitation | 11/598,950 |
| Aperture correction for lenticular screens | 11/701,995 |
| Soft aperture correction for lenticular screen | 11/880,828 |
| Synthetic Panoramagram | 6,366,281 |
| Maximizing the Viewing Zone of a Lenticular | 6,519,088 |
| Stereogram | |
| Parallax Panoramagram Having Improved Depth and | 6,850,210 |
| Sharpness | |
| Neutralizing device for autostereoscopic lens sheet | 6,985,296 |
| Autostereoscopic lenticular screen | 7,099,080 |

All of the items listed in Table 1 are incorporated herein by reference in their entirety. These patents and applications are cited because a SynthaGram according to these disclosures is used to implement the viewing of autostereoscopic images in an embodiment of this disclosure, the conversion of planar images to multi-tile, multi-perspective images as explained in the various SynthaGram disclosures cited. Image files of the multi-tile variety are sent to and received by the user and displayed on a digital photo frame using the SynthaGram lenticular technology cited. In this way the user is able to enjoy three-dimensional images viewed without eyewear in a digital photo frame dedicated to the display of images, where the images are derived from a device such as an ordinary planar camera and processed by the Service Bureau.

As an alternative, a handheld viewing device such as a cell phone or a personal digital assistant can be used for viewing any of these image variants either in combination with and using a lenticular screen or, for example, by anaglyph or other means such as a head mounted display or selection device. Such devices may also be used to capture two dimensional images if equipped with a camera type functionality, or another appropriately configured devices may be employed to capture the two dimensional image and the image so captured may be provided to the Service Bureau 102.

The present design therefore includes an infrastructure for producing stereoscopic snapshots or photos to be viewed as hardcopy, or on an electronic display screen using a variety of selection device technologies.

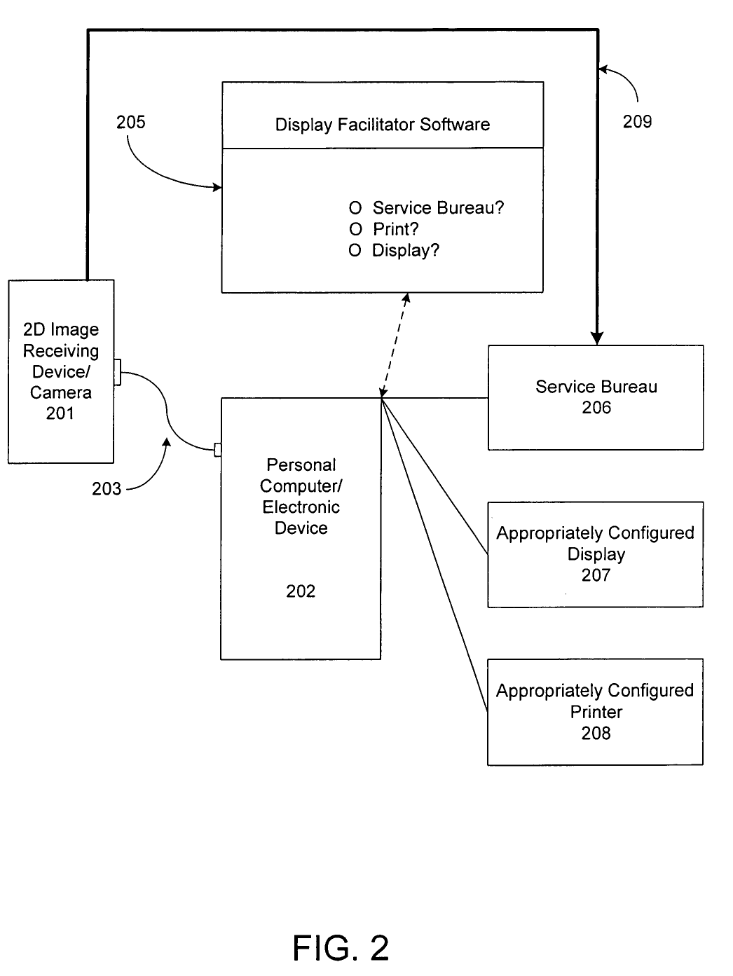

FIG. 2 illustrates one alternative for effectuating or realizing the design. Once the digital images have been captured at the capture device 201, such as a planar camera or two dimensional image capturing device, the images may be provided to a personal computer or other electronic device 202 via a connection, either wired as shown via wire 203 or wirelessly. The receiving device or camera(s) 201 may have transmitting capabilities and/or be configured to transmit to a remote device. Once received by the PC or other electronic device 202, the user may be presented with a series of options via software such as software 205 or may simply save the files locally and/or transmit them to a third party or one of the devices suggested (such as a printer). The software 205 may provide the user with a series of options as to how he wishes to receive or view the resultant stereoscopic images, including the aforementioned transmission to the service bureau 206, an appropriate configured display 207 for viewing, or to an appropriately configured printer 208. Such a software program facilitates distribution and display of the images received and their processing for display either via printing, service bureau, or electronic display. The device may provide the images to the service bureau via email, ftp transfer, or other reasonable and acceptable method, may employ secure delivery methods, and may process the images using software located on the PC as discussed above if display or hardcopy printing is desired.

Alternately, the camera 201 may be physically taken or transmitted by known means, to the service bureau 206 via path 209, and the service bureau 206 may process the images from the camera 201 and provide the desired print or hardcopy to the user. The camera 201 may provide for a memory stick (not shown) or digital card or other memory storage disk or device for purposes of removing the images and providing them to another device. Various computing devices, including but not limited to other PCs, wireless devices, servers, routers, and so forth may be used between the camera and the device or devices used to process and/or display the stereoscopic image. Thus the display facilitator may take various forms, such as a software program, a person physically facilitating distribution among the various display options, intermediate devices, or some other reasonable distribution and display arrangement for the digital images. The present design is not intended to be limiting in this regard but rather expansive in implementation possibilities.

Moreover, the three dimensional converted image may be outputted on an electronic display panel to serve as a framed three dimensional picture of the type that is presently commercially available. Essentially these are devices for playing back image files, configured for stereoscopic or autostereoscopic imager display, often playing back images as a slide show, in a picture frame device incorporating a display panel and associated memory and electronics. In this case the preferred means would include a display screen overlaid with a lenticular sheet of the type described above with an image processed to produce the associated panoramagram image. The processed panoramagram files, interpolated from a stereo pair, can be produced by a service bureau as described above.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for enabling viewing of stereoscopic images, comprising:
providing a two dimensional image representation to a service bureau configured to convert the two dimensional image representation into a stereoscopic image; and
transmitting the enhanced image from the service bureau to an entity for purposes of displaying the images in a user desired configuration.

2. The method of claim 1, further comprising employing a digital photo frame to display the enhanced image.

3. The method of claim 1, wherein producing the two dimensional image representation comprises obtaining a two dimensional image using an image recording device configured to convert the two dimensional image into a digital computer readable file.

4. The method of claim 1, wherein conversion of the two dimensional image representation to the enhanced image enables displaying the stereoscopic image in at least one display mode selected from a group comprising:
a digital photo frame;
display of an anaglyph;
a Micropol type display;
display using a SynthaGram type device; and
time multiplexed images shown on a display.

5. The method of claim 1, wherein the service bureau comprises a third party having an ability to convert the two dimensional representation into an enhanced image and print the stereoscopic image in at least one format selected from a group comprising:
two dimensional prints;
anaglyph prints;
stereoscope prints;
lenticular files; and
lenticular prints.

6. The method of claim 1, wherein the stereoscopic image is made available by the service bureau in at least one format selected from a group comprising:
a two dimensional print;
an anaglyph print;
a stereoscope print; and
a print clearly viewable using a lenticular array.

7. The method of claim 3, wherein the at least one image recording device comprises a camera.

8. The method of claim 1, wherein the service bureau receives the two dimensional image representation via a display facilitator, said display facilitator comprising one from a group comprising a person and software configures to select between various display options.

9. A method of viewing stereoscopic images, comprising:
obtaining a two dimensional digital image representation;
directing distribution of the two dimensional image representation to a service bureau configured to convert one two dimensional image into one stereoscopic image; and
receiving a stereoscopic representation of the two dimensional image representation for stereoscopic image viewing purposes.

10. The method of claim 9, wherein directing distribution comprises employing a display facilitator comprising software configured on a computing device.

11. The method of claim 9, wherein the two dimensional digital image representation is obtained using an optical image receiving device configured to receive and convert optical images into digital image representations.

12. The method of claim 9, further comprising providing the stereoscopic representation to a digital photo frame.

13. The method of claim 9, wherein the service bureau is configured to provide one stereoscopic image in at least one format selected from a group comprising:
two dimensional prints;
anaglyph prints;
stereoscope prints;
lenticular files; and
lenticular prints.

14. The method of claim 9, wherein the at least one image recording device comprises a camera.

15. The method of claim 9, further comprising wherein said directing comprises at least one from a group comprising a person and software.

16. A method for providing a stereoscopic image to a user in a desired format, comprising:
receiving a two dimensional electronic image representation in electronic form together with conversion criteria;
converting the two dimensional electronic image representation into a stereoscopic image based on the conversion criteria; and
providing the stereoscopic image to a user for display.

17. The method of claim 16, wherein the two dimensional image representation is provided via a display facilitator comprising software configured on a computing device.

18. The method of claim 16, wherein the two dimensional image representation is obtained from an optical receiving device configured to receive images and convert the images into electronic form.

19. The method of claim 16, wherein the conversion criteria comprise at least one from a group comprising:
user desired stereoscopic effects; and
conversion settings.
